(19) United States
(12) Patent Application Publication
(10) Pub. No.: US 2010/0026895 A1
(43) Pub. Date: Feb. 4, 2010

(54) APPARATUS AND METHOD FOR CONTROLLING DISPLAY TIME OF ON-SCREEN-DISPLAY

(75) Inventor: Heun-Jin LEE, Seoul (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/483,766

(22) Filed: Jun. 12, 2009

(30) Foreign Application Priority Data
Aug. 4, 2008 (KR) 10-2008-0075985

(51) Int. Cl. H04N 5/50

(52) U.S. Cl. 348/569; 348/E05.097

(57) ABSTRACT

An apparatus and a method for controlling a display time of an OSD are provided. The apparatus includes a display unit and a controller. The display unit displays an OSD icon. The controller removes the OSD icon based on a screen change of the display unit.

### PRIORITY

The present application claims the benefit under 35 U.S.C. §119(a) of a Korean patent application filed in the Korean Intellectual Property Office on Aug. 4, 2008 and assigned Serial No. 10-2008-0075985, the entire disclosure of which is hereby incorporated by reference.

### BACKGROUND OF THE INVENTION

1. Field of the Invention

The present invention relates generally to an apparatus including a display unit. More particularly, the present invention relates to an apparatus and a method for controlling a display time of an On-Screen-Display (OSD) in an apparatus including a display unit.

2. Description of the Related Art

An OSD is used for controlling an apparatus including a display unit. The OSD is displayed in an overlapping form on a screen for an original purpose of the apparatus. For example, a channel display and a volume control display in a TeleVision (TV), a screen control display in a computer monitor, a control menu display using Function (Fn) keys in a laptop computer and a volume control display in a portable electronic apparatus correspond to the OSD.

When an OSD is used, a user may intuitively recognize a status of an apparatus and control the apparatus. For example, an OSD of FIG. 1A may be used for selecting whether to output sound from the apparatus, an OSD of FIG. 1B may be used for selecting a screen output method, and an OSD of FIG. 1C may be used for selecting an activation/inactivation of a touchpad. Accordingly, an OSD icon is constantly displayed for a certain time. Here, when a display time of an OSD icon is too short, a time for recognizing the OSD icon and inputting an instruction in response thereto is not guaranteed. Therefore, the display time of the OSD icon should be determined with consideration of time consumed for a user to recognize the OSD icon and input an instruction thereto.

However, since an OSD screen is displayed having an overlapping form and for a certain time, the underlying original screen of the apparatus is hidden. For example, in the case where a user who views a moving image on a laptop computer interfaces with an OSD for controlling a volume, the user cannot watch the moving image for the certain time due to an OSD icon for controlling the volume. Also, an OSD icon size may occupy a large portion of a screen depending on the purpose of the OSD and characteristic of the apparatus. In this case, a range of the screen which cannot be seen is widened.

Therefore a need exists for an apparatus and method for preventing a screen from being hidden dye to an OSD icon.

### SUMMARY OF THE INVENTION

An aspect of the present invention is to address at least the above-mentioned problems and/or disadvantages and to provide at least the advantages described below. Accordingly, an aspect of the present invention is to provide an apparatus and a method for preventing a screen in an apparatus including a display unit from being hidden for a long time due to an On-Screen-Display (OSD) icon.

Another aspect of the present invention is to provide an apparatus and a method for removing an OSD icon in an apparatus including a display unit depending on a user's input and a screen status.

Still another aspect of the present invention is to provide an apparatus and a method for removing an OSD icon in an apparatus including a display unit when a screen is changed by a user's manipulation.

Further another aspect of the present invention is to provide an apparatus and a method for removing an OSD icon in an apparatus including a display unit when a screen is changed by an operation of the apparatus.

Yet another aspect of the present invention is to provide an apparatus and a method for recognizing a screen change in an apparatus including a display unit.

In accordance with an aspect of the present invention, an apparatus including a display unit is provided. The apparatus includes a display unit for displaying an On-Screen-Display (OSD) icon, and a controller for removing the OSD icon based on a screen change of the display unit.

In accordance with another aspect of the present invention, a method for displaying an On-Screen Display (OSD) icon of an apparatus including a display unit is provided. The method includes displaying an OSD icon on a display unit, and removing the OSD icon based on a screen change of the display unit.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other objects, features and advantages of certain exemplary embodiments of the present invention will be more apparent from the following description taken in conjunction with the accompanying drawings, in which:

FIGS. 1A to 1C illustrate examples of a conventional OSD in an apparatus including a display unit;

FIG. 2 is a flowchart illustrating a procedure for displaying an OSD in an apparatus including a display unit according to an exemplary embodiment of the present invention; and

FIG. 3 is a block diagram illustrating an apparatus including a display unit according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

Exemplary embodiments of the present invention prevent a screen in an apparatus including a display unit from being hidden for a long time due to an On-Screen-Display (OSD) icon. Examples of the apparatus including the display unit may include a laptop computer, a desktop computer, an electronic note, a portable electronic apparatus, such as a portable digital media player, and the like. Hereinafter, a laptop computer is illustrated by way of example. However, all apparatuses including display units may be applicable.

The apparatus including a display unit according to an exemplary embodiment of the present invention controls a display time of an OSD icon in accordance with at least one of the following two methods.

First, a method according to a screen change by a user's manipulation is described. For example, in the case where a user scrolls a screen or moves a window on a laptop computer, the apparatus including the display unit removes the OSD icon. At this point, in case of an apparatus, such as a computer which uses an Operating System (OS), occurrence information of an event, such as screen scroll, window movement and window minimization/maximization is provided by the OS. Therefore, the apparatus including the display unit may recognize occurrence of the above-listed events through information provided from the OS.

Second, a method according to a screen change by an operation of the apparatus is described. In other words, the apparatus including the display unit determines whether a neighborhood of a display region of the OSD icon changes, and removes the OSD icon when a change occurs. Accordingly, the apparatus including the display unit periodically captures a screen and determines whether the screen changes by comparing a previous capture screen with a current capture screen. In an exemplary implementation, the screen which is used for comparison may be an entire screen, but numerous calculations are required in the case where the entire screen is used. Therefore, the apparatus including the display unit may use pixels inside the neighboring region of the OSD icon or reduce the number of pixels to be used for comparison through sampling.

According to the second method, whether the screen changes is determined based on whether a rate of change between two successively captured screens exceeds a threshold. In an exemplary implementation, the rate of change may be determined using one of various methods, such as a Mean Square Error (MSE), a correlation coefficient, a histogram and an edge histogram. For example, the rate of change may be determined using a correlation coefficient as in Equation (1) below.

$$γ = \frac{{{\sum }_{n}}^{N} {\sum }_{m}^{M} [ f ( m , n ) - \overline{f} ] [ w ( m , n ) - \overline{w} ]}{{\{ {\sum }_{n}^{N} {\sum }_{m}^{M} {[ f ( m , n ) - \overline{f} ]}^{2} {\sum }_{n}^{N} {\sum }_{m}^{M} {[ w ( m , n ) - \overline{w} ]}^{2} \}}^{{1}^{′} 2}} \qquad ( 1 )$$

In Equation (1), f(m,n) is a pixel value at a coordinate (m,n) on a previous capture screen, w(m,n) is a pixel value at a coordinate (m,n) on a current capture screen, f̅ is an average of pixel values inside a previous capture screen and w̅ is an average of pixel values inside a current capture screen.

However, since the correlation coefficient is an index denoting a similarity between two screens, the OSD icon may be removed when the correlation coefficient is less than a threshold. That is, in the case where the correlation coefficient is used, a rate of similarity is determined instead of a rate of change.

As described above, the apparatus including the display unit according to an exemplary embodiment of the present invention controls a display time of the OSD icon using at least one of the two methods. In an exemplary implementation, one of the two methods may be selectively used or the two methods may be simultaneously used. For example, in the case where event occurrence information is not provided by an OS, the second method may be used. Also, in the case where a screen is constantly changing, such as a moving image, reproduction may be recognized, the second method may be adaptively used during a moving image reproduction status and the first method may be adaptively used during other statuses.

Also, in the above-described method for controlling a display of an OSD icon, the removing of the OSD icon may cause the OSD icon to be immediately unseen, to disappear before a certain display time, and to disappear after a certain time elapses.

Hereinafter, an operation and construction of an apparatus including a display unit, which controls a display time of an OSD icon is illustrated according to an exemplary embodiment of the present invention with reference to the accompanying drawings.

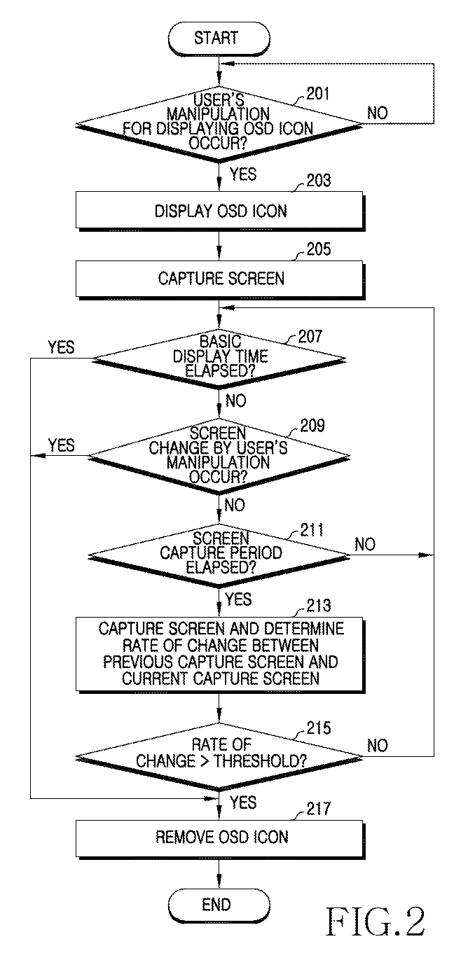

FIG. 2 is a flowchart illustrating a procedure for displaying an OSD in an apparatus including a display unit according to an exemplary embodiment of the present invention.

Referring to FIG. 2, in step 201, the apparatus including the display unit determines whether a user's manipulation for displaying an OSD icon occurs. For example, in case of a laptop computer, the apparatus including the display unit determines whether key input for displaying a control menu using a function key occurs.

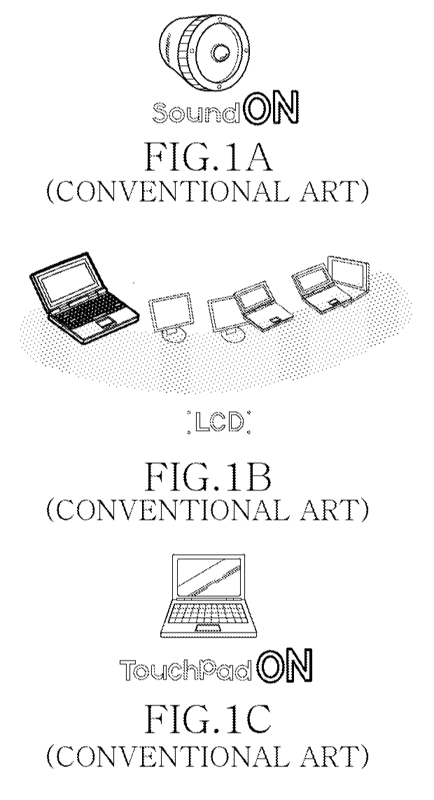

When the user's manipulation for displaying the OSD icon occurs, the apparatus including the display unit displays an OSD icon corresponding to the user's manipulation in step 203. For example, the OSD icon may be one of the OSD icon for selecting whether to output sound outside from the apparatus (FIG. 1A), the OSD icon for selecting a screen output method (FIG. 1B) and the OSD icon for selecting an activation/inactivation of a touchpad (FIG. 1C).

The apparatus including the display unit captures a screen in order to determine a rate of screen change after displaying the OSD icon in step 205. Accordingly, the apparatus including the display unit captures an entire screen or a portion of the screen specified by the displayed OSD icon. Here, a range of the portion of the screen specified by the displayed OSD icon denotes a range hidden by the OSD icon or a partial range around the range hidden by the OSD icon. Also, the range of the screen to be captured may be determined according to a rule set in advance.

After capturing the screen, the apparatus including the display unit determines whether a basic display time has elapsed since the displaying of the OSD icon in step 207. Here, the basic display time denotes a time for which the displaying of the OSD icon is maintained when an event corresponding to the first method or the second method does not occur. When the basic display time has elapsed, the apparatus including the display unit removes the OSD icon in step 217.

On the other hand, when the basic display time has not elapsed, the apparatus including the display unit determines whether a screen change by a user's manipulation occurs in step 209. That is, the apparatus including the display unit determines whether an event corresponding to the first method occurs. For example, in the case where the apparatus including the display unit uses an OS, since occurrence information of the event is generated by the OS, the apparatus including the display unit determines whether occurrence information of the event is generated by the OS. When the screen change by the user's manipulation occurs, the apparatus including the display unit removes the OSD icon in step 217.

When the screen change by the user's manipulation does not occur, the apparatus including the display unit determines whether a screen capture period has elapsed in step 211. That is, the apparatus including the display unit determines whether a point for capturing a screen again has arrived. When the screen capture period has not elapsed, the apparatus including the display unit returns to step 207.

On the other hand, when the screen capture period has elapsed, the apparatus including the display unit captures a screen and determines a rate of change between the previous capture screen and the current capture screen in step 213. At this point, the apparatus including the display unit captures the same range of the screen as the range in step 205. Also, to reduce a calculation amount, the apparatus including the display unit may reduce a number of pixels used for determining the rate of change by performing sampling on pixels inside the captured screen. For example, the apparatus including the display unit may determine the rate of change using one of MSE, a correlation coefficient, a histogram and an edge histogram.

After determining the rate of change, the apparatus including the display unit compares the rate of change with a threshold in step 215. When the rate of change is less than or equal to the threshold, the apparatus including the display unit determines that the screen does not change and returns to step 207.

On the other hand, when the rate of change is greater than the threshold, the apparatus including the display unit determines that the screen has changed and removes the OSD icon in step 217.

FIG. 2 illustrates an example of a case where the above-described first method and second method are used simultaneously. However, as described above, one of the first method and the second method may be selectively used. In the case where the first method is selectively used, step 205 and steps 211 to 215 are omitted. In the case where the second method is selectively used, step 209 is omitted.

Also, in the procedure described with reference to FIG. 2, the apparatus including the display unit determines a rate of change between two screens. A rate of similarity may be determined instead of the rate of change depending on an image comparison technique used. For example, the rate of change is determined in the case where an MSE technique is used, and the rate of similarity is determined in the case where a correlation coefficient technique is used. Therefore, in an exemplary implementation, an apparatus including a display unit determines a rate of similarity, compares the rate of similarity with a threshold, and when the rate of similarity is less than the threshold, removes the OSD icon.

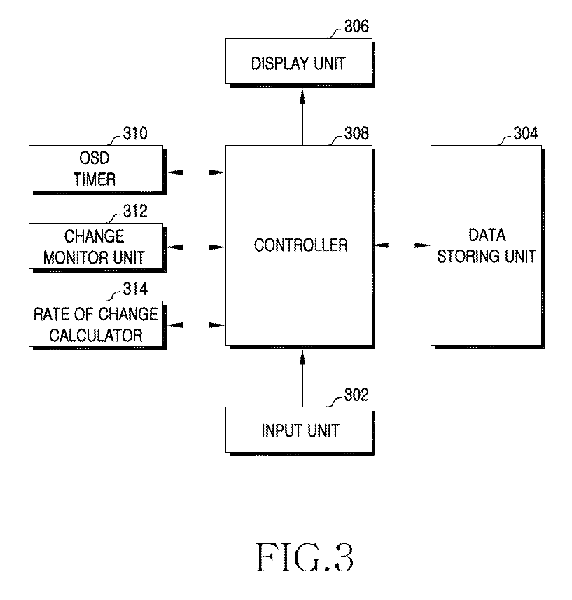

FIG. 3 is a block diagram illustrating an apparatus including a display unit according to an exemplary embodiment of the present invention.

Referring to FIG. 3, the apparatus including the display unit includes an input unit 302, a data storing unit 304, a display unit 306, a controller 308, an OSD timer 310, a change monitor unit 312 and a rate of change calculator 314.

The input unit 302 recognizes an input generated by a user and provides information corresponding to the input to the controller 308. For example, the input unit 302 processes the user's input through a keypad, a touchscreen, a touchpad, a mouse and the like. The data storing unit 304 stores applications for operating the apparatus including the display unit, temporary data and storage data. The data storing unit 304 also provides a stored program or stored data to the controller 308 under control of the controller 308.

The display unit 306 serves as a display means of the apparatus including the display unit, and displays status information occurring during an operation of the apparatus, numbers, letters, images and the like generated during execution of an application. More particularly, the display unit 306 displays an OSD icon under control of the controller 308. For example, the display unit 306 may be one of a Cathode Ray Tube (CRT), a Liquid Crystal Display (LCD), an Organic Light-Emitting Diode (OLED) and the like.

The controller 308 controls an overall function of the apparatus including the display unit. The controller 308 determines whether a user's manipulation for displaying an OSD icon occurs according to information provided from the input unit 302, and controls the display unit 306 to display an OSD icon corresponding to the user's manipulation. More particularly, the controller 308 controls the display unit 306 to remove a displayed OSD icon depending on status information informed from the OSD timer 310, the change monitor unit 312 and the rate of change calculator 314. That is, when the OSD timer 310 informs that a basic display time has elapsed, or the change monitor unit 312 informs that screen change by a user's manipulation has occurred, the controller 308 controls the display unit 306 to remove the OSD icon. Also, when the rate of change calculator 314 informs a rate of change, the controller 308 compares the rate of change with a threshold, and when the rate of change is greater than the threshold, the controller 308 controls the display unit 306 to remove the OSD icon.

After the display unit 306 displays the OSD icon, the OSD timer 310 determines that the basic display time has elapsed. Here, the basic display time denotes a time for which the displaying of the OSD icon is maintained while an event corresponding to the first method or the second method does not occur. When the basic display time has elapsed, the OSD timer 310 informs the controller 308 that the basic display time has elapsed.

While the display unit 306 displays the OSD icon, the change monitor unit 312 detects whether a screen change by a user's manipulation occurs. That is, the change monitor unit 312 determines whether an event corresponding to the first method occurs. For example, the apparatus including the display unit uses an OS, since occurrence information of the event is generated by the OS. The change monitor unit 312 then determines whether event occurrence information by the OS is generated. When the screen change by the user's manipulation occurs, the change monitor unit 312 informs the controller 308 that the screen change by the user's manipulation occurs.

While the display unit 306 displays the OSD icon, the rate of change calculator 314 captures a screen periodically. Also, the rate of change calculator 314 determines a rate of change between successively captured two screens. At this point, the rate of change calculator 314 captures an entire screen or a portion of the screen specified by the OSD icon. Here, a range of the portion of the screen specified by the OSD icon denotes a range hidden by the OSD icon, or a partial range around the range hidden by the OSD icon. Also, to reduce a calculation amount, the rate of change calculator 314 may reduce the number of pixels used for determining the rate of change by performing sampling on pixels inside the captured screen.

In the apparatus described with reference to FIG. 3, the rate of change calculator 314 determines the rate of change between two screens. A rate of similarity may be determined instead of the rate of change depending on an image comparison technique used. For example, the rate of change is determined in the case where an MSE technique is used, and the rate of similarity is determined in the case where a correlation coefficient technique is used. Therefore, according to an exemplary embodiment of the present invention, the rate of change calculator 314 determines the rate of similarity, and the controller 308 compares the rate of similarity with a threshold. When the rate of similarity is less than the threshold, the controller 308 controls the display unit 306 to remove the OSD icon.

In the exemplary embodiments of the present invention, an apparatus including a display unit may minimize a user's inconvenience caused by hiding of the screen due to an OSD icon by removing the OSD icon depending on the user's input and a screen status.

Exemplary embodiments of the present invention can also comprise computer readable codes on a computer readable medium. The computer readable medium can comprise any data storage device that can store data that can be read by a computer system. Examples of a computer readable medium include magnetic storage media (such as, ROM, floppy disks, hard disks, among others), optical recording media (such as, CD-ROMs, or DVDs), and storage mechanisms such as carrier waves (such as, transmission through the Internet). The computer readable medium can also be distributed over network coupled computer systems so that the computer readable code is stored and executed in a distributed fashion. Also, functional programs, codes, and code segments for accomplishing exemplary embodiments of the present invention can be construed by programmers of ordinary skill in the art to which the present invention pertains

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An apparatus including a display unit, the apparatus comprising:
a display unit for displaying an On-Screen-Display (OSD) icon; and
a controller for removing the OSD icon based on a screen change of the display unit.

2. The apparatus of claim 1, further comprising a calculator for capturing the screen after the displaying of the OSD icon, for capturing the screen again when a screen capture period elapses, and for determining one of a rate of change and a rate of similarity between the two successively captured screens,
wherein the controller removes the OSD icon when one of the rate of change is greater than a threshold and the rate of similarity is less than a threshold.

3. The apparatus of claim 2, wherein the calculator captures one of an entire screen and a portion of the screen specified by the OSD icon.

4. The apparatus of claim 3, wherein the calculator determines the one of the rate of change and the rate of similarity using one of a Mean Square Error (MSE), a correlation coefficient, a histogram and an edge histogram.

5. The apparatus of claim 4, wherein the calculator reduces the number of pixels used for determining the one of the rate of change and the rate of similarity by performing sampling on pixels inside the captured screen.

6. The apparatus of claim 1, further comprising a monitor unit for detecting whether a screen change by a user's manipulation occurs,
wherein the controller removes the OSD icon when the screen change by the user's manipulation occurs.

7. The apparatus of claim 1, further comprising a timer for determining whether a basic display time has elapsed since the displaying of the OSD icon,
wherein the controller removes the OSD icon when the basic display time has elapsed.

8. A method for displaying an On-Screen Display (OSD) icon of an apparatus including a display unit, the method comprising:
displaying an OSD icon on a display unit; and
removing the OSD icon based on a screen change of the display unit.

9. The method of claim 8, wherein the removing of the OSD icon comprises:
capturing the screen after the displaying of the OSD icon;
capturing the screen again when a screen capture period elapses;
determining one of a rate of change and a rate of similarity between the two successively captured screens; and
when one of the rate of change is greater than a threshold and the rate of similarity is less than a threshold, removing the OSD icon.

10. The method of claim 9, wherein the capturing of the screen comprises capturing one of an entire screen and a portion of the screen specified by the OSD icon.

11. The method of claim 10, wherein the one of the rate of change and the rate of similarity is determined using one of a Mean Square Error (MSE), a correlation coefficient, a histogram and an edge histogram.

12. The method of claim 11, further comprising reducing the number of pixels used for the determining of one of the rate of change and the rate of similarity by performing sampling on pixels inside the captured screen, prior to the determining of one of the rate of change and the rate of similarity.

13. The method of claim 8, wherein the removing of the OSD icon comprises:
determining whether a screen change by a user manipulation occurs; and
when the screen change by the user's manipulation occurs, removing the OSD icon.

14. The method of claim 8, further comprising:
determining whether a basic display time has elapsed since the displaying of the OSD icon; and
when the basic display time has elapsed, removing the OSD icon.

15. A method for controlling a display time of an On-Screen Display (OSD) icon by removing the OSD icon based on a screen change of an apparatus including a display unit, the method comprising:
capturing a screen after displaying an OSD icon;
capturing the screen again when a screen capture period elapses;
determining one of a rate of change and a rate of similarity between the two successively captured screens; and
when the rate of change is greater than a threshold or the rate of similarity is less than a threshold, removing the OSD icon.

16. The method of claim 15, wherein the capturing of the screen comprises capturing one of an entire screen and a portion of the screen specified by the OSD icon.

17. The method of claim 16, wherein the one of the rate of change and the rate of similarity is determined using one of a Mean Square Error (MSE), a correlation coefficient, a histogram and an edge histogram.

18. The method of claim 17, further comprising reducing the number of pixels used for the determining of one of the rate of change and the rate of similarity by performing sampling on pixels inside the captured screen, prior to the determining of one of the rate of change and the rate of similarity.

19. The method of claim 15, further comprising:
determining whether a screen change by a user manipulation occurs; and
when the screen change by the user's manipulation occurs, removing the OSD icon.

20. The method of claim 15, further comprising:
determining whether a basic display time has elapsed since the displaying of the OSD icon; and
when the basic display time has elapsed, removing the OSD icon.
